(19) United States
(12) Patent Application Publication
(10) Pub. No.: US 2007/0123626 A1
(43) Pub. Date: May 31, 2007

(54) HEAT RESISTANT LIGHT DIFFUSION BLEND COMPOSITION

(75) Inventors: Seo-hwa KIM, Daejeon (KR); Ju-hwa LEE, Pyeongtaek-si, Gyeonggi-do (KR); Bong-keun LEE, Daejeon (KR); Jae-chan PARK, Daejeon (KR); Hyun-seok YANG, Daejeon (KR)

Correspondence Address: CANTOR COLBURN, LLP, 55 GRIFFIN ROAD SOUTH, BLOOMFIELD, CT, 06002, US

(73) Assignee: LG CHEM, LTD., Seoul (KR)

(21) Appl. No.: 11/552,314

(22) Filed: Oct. 24, 2006

(30) Foreign Application Priority Data
Oct. 25, 2005 (KR) 10-2005-0100738

(51) Int. Cl. C08K 3/30

(52) U.S. Cl. 524/423; 524/425; 524/445; 524/449; 524/431; 524/493

(57) ABSTRACT

The present invention relates to a heat resistant light diffusion blend composition, and more precisely, a heat resistant light diffusion blend composition which is composed of a substrate resin prepared by blending styrene-maleic anhydride copolymer resin and polymethylmethacrylate resin and a light-diffusing agent composed of acrylic organic particles with a mean diameter of 1˜20 μm alone or together with silicon organic particles with a mean diameter of 0.5˜20 μm. Therefore, the heat resistant light diffusion blend composition of the present invention not only has high diffusivity and brightness but also excellent heat resistance, dimensional stability and mechanical properties with a low water absorption rate, so that this composition can be effectively used as a light diffusion plate and also be applied to a backlight for LCDs, lighting apparatus, signboards or glass showcases.

This application claims the benefit of the filing date of Korean Patent Application No. 10-2005-0100738 filed on Oct. 25, 2005 in the Korean Intellectual Property Office, the disclosure of which is incorporated herein in its entirety by reference.

### TECHNICAL FIELD

The present invention relates to a heat resistant light diffusion blend composition, and more precisely, a heat resistant light diffusion blend composition which has high diffusivity and brightness that may be effectively used as a light diffusion plate, has a low water absorption rate with excellent heat resistance, dimensional stability and mechanical strength, and thus it can be applied to a back-light-unit for LCDs, lighting apparatus, signboards or glass showcases, etc.

### BACKGROUND ART

Optical materials must have excellent thermo-mechanical properties which are good enough to adapt to their surroundings, in addition to having excellent optical characteristics. Polymethylmethacrylate has been widely used as an optical material owing to its excellent light transmittance and low haze, and in particular it has recently been applied to the light diffusion plate of an LCD back-light-unit.

In general, a light diffusion sheet presents a point light source or line light source as a surface light source. The back-lights or contents for the light diffusion sheet are hidden. High diffusivity is required for the sheet to provide regular brightness, as is high brightness on the emission light surface to increase light efficiency (high brightness, low power consumption). However, polymethylmethacrylate resin has a high water absorption rate, which decreases the thermo-mechanical properties, and a low storage modulus at high temperature, so that bending of the light diffusion material is often observed due to the light source temperature rise when it is used as a light diffusion plate.

Japanese Laid-Open Patent Publication No. Hei 1-172801 describes a light diffusion plate which has improved light diffusivity and light transmittance by dispersing silicon particles on the transparent thermoplastic resin polymethylmethacrylate. According to the above description, both light transmittance and light diffusivity could be increased by using silicon particles, but mechanical strength and thermo-resistance were reduced by the high water absorption of the polymethylmethacrylate.

Korean Patent Application No. 2003-36078, Japanese Laid-Open Patent Publication No. Hei 11-5241, and Japanese Laid-Open Patent Publication No. Hei 7- 100985 describe how methylmethacrylate and styrene copolymer are produced, to which at least two resins having different contents of light diffusing agents are added to prepare different laminated plates, and at least two different laminated plates are then applied to a light diffusion plate. According to the above descriptions, they tried to inhibit deformity in the resin laminated plate caused by water absorption by using a styrene resin having a low water absorption rate for the copolymerization. But, the production cost of methylmethacrylate-styrene copolymer is high and the storage modulus of methylmethacrylate-styrene copolymer at high temperature is reduced because of the low heat resistance of the styrene resin.

Suzuki and his colleagues studied the bending of a light diffusion plate for an LCD under the conditions of 60° C. and 95% relative humidity. They found that polymethylmethacrylate, which has been used as a light diffusion plate, is apt to bend or not bend according to the humidity and thermal properties.

As a substrate resin for a light diffusion plate, using polymethylmethacrylate alone or styrene alone has been tried, and methylmethacrylate-styrene copolymer has been used.

In the case of using polymethylmethacrylate alone as the substrate resin, the above mentioned problems still remain, and in the case of using styrene alone as the substrate resin, heat resistance is reduced and thus storage modulus at high temperature is reduced and production cost increases. The methylmethacrylate-co-styrene copolymer is a kind of MS resin in which methylmethacrylate monomer and styrene monomer form a chain together by random or block binding. Adding styrene monomer to polymethylmethacrylate can reduce water absorption rate, which has been a problem of polymethylmethacrylate, but cannot improve heat resistance, so heat resistance of a light diffusion plate is still unsatisfactory, particularly when the backlights are on. In addition, the copolymerization of methylmethacrylate and styrene is very complicated and inefficient economically.

### DISCLOSURE OF THE INVENTION

It is an object of the present invention, in order to solve the above problems, to provide a heat resistant light diffusion blend composition which has high diffusivity and brightness so as to be easily applied as a light diffusion plate, and a light diffusion plate containing the same.

It is another object of the present invention to provide a heat resistant light diffusion blend composition having excellent heat resistance, dimensional stability and mechanical strength and a low water absorption rate, and a light diffusion plate using the same.

It is a further object of the present invention to provide a heat resistant light diffusion blend composition applicable to a back-light-unit for LCDs, lighting apparatus, signboards or glass showcases, and a light diffusion plate using the same.

To achieve the above objects, the present invention provides a heat resistant light diffusion blend composition comprising:
a) 100 weight part of a substrate resin prepared by blending
i) 20˜90 weight % of styrene-maleic anhydride copolymer resin, and
ii) 10˜80 weight % of polymethylmethacrylate resin; and
b) a light-diffusing agent prepared by blending either
i) 0.05˜10 weight part of acrylic organic particles with a mean diameter of 1˜20 μm, or
ii) 0.05˜10 weight part of silicon organic particles with a mean diameter of 0.5˜20 μm, or a mixture thereof.

The present invention also provides a light diffusion plate which characteristically contains the heat resistant light diffusion blend composition.

Hereinafter, the present invention is described in detail.

The present inventors prepared a mixed resin by blending polymethylmethacrylate resin with styrene-maleic anhydride copolymer resin, and used the mixed resin as a substrate resin. The present inventors completed this invention by confirming that the use of the substrate resin of the present invention could significantly improve the heat resistance and other physical properties of a light diffusion blend composition, and further improve diffusivity and brightness when being applied to a light diffusion plate.

The heat resistant light diffusion blend composition of the present invention characteristically contains 100 weight part of the substrate resin prepared by blending 20˜90 weight % of styrene-maleic anhydride copolymer resin and 10˜80 weight % of polymethylmethacrylate resin, and a light-diffusing agent containing 0.05˜10 weight part of acrylic organic particles with a mean diameter of 1˜20 μm alone or together with 0.05˜10 weight part of silicon organic particles with a mean diameter of 0.5˜20 μm.

The styrene-maleic anhydride copolymer resin of a) i) of the present invention is prepared by copolymerization of styrene monomer and maleic anhydride monomer.

The styrene monomer can be selected from a group consisting of styrene, α-methyl styrene, p-bromo styrene, p-methyl styrene and p-chloro styrene.

The preferable content of the styrene monomer in the total monomer for the styrene-maleic anhydride copolymer resin is 70˜96 weight % and 80˜94 weight % is more preferred.

The maleic anhydride (MAH) monomer is an unsaturated monomer which can be used for the copolymerization with the styrene monomer. The preferable content of the maleic anhydride monomer in the total monomer for the styrene-maleic anhydride copolymer resin is 4˜30 weight % and 6˜20 weight % is more preferred. If the content is less than 4%, heat resistance of the styrene-maleic anhydride copolymer resin will not be improved. On the contrary, if the content is more than 30 weight %, impact strength of the styrene-maleic anhydride copolymer resin will be reduced, suggesting that the resin is not applicable to a transparent resin.

The preferable content of the styrene-maleic anhydride copolymer resin in the substrate resin mixture is 20˜90 weight % and 50˜85 weight % is more preferred. If the content is less than 20 weight %, the water absorption rate will be increased and thereby heat resistance and mechanical properties will be reduced. On the contrary, if the content is more than 90 weight %, the impact strength of the final resin composition will be reduced.

The polymethylmethacrylate resin of a) ii ) of the present invention is preferably a polymer containing methyl methacrylic acid methylester of at least 50 weight %.

Particularly, the polymethylmethacrylate resin is a polymer polymerized with methyl methacrylic acid methylester alone or copolymerized with methyl methacrylic acid methylester (at least 50 weight %) and an unsaturated monomer copolymerizable with the above (up to 50 weight %).

The unsaturated monomer copolymerizable with methyl methacrylic acid methylester can be one or more compounds selected from a group consisting of ester methacrylic acids such as ethyl methacrylic acid, butyl methacrylic acid, cyclohexyl methacrylic acid, phenyl methacrylic acid, benzyl methacrylic acid, 2-ethylhexyl methacrylic acid and 2-hydroxyethyl methacrylic acid; ester acrylic acids such as methyl acrylic acid, ethyl acrylic acid, butyl acrylic acid, cyclohexyl acrylic acid, phenyl acrylic acid, benzyl acrylic acid, 2-ethylhexyl acrylic acid and 2-hydroxyethyl acrylic acid; styrene, α-methyl styrene, acrylonitrile, phenyl maleimide and cyclohexyl maleimide.

The preferable content of the polymethylmethacrylate resin in the substrate resin is 10˜80 weight % and a more preferable content is 15˜50 weight %. If the content is less than 10 weight %, the impact strength of the final resin composition will be reduced. On the contrary, if the content is more than 80 weight %, the water absorption rate will be increased and thereby the heat resistance and other mechanical properties will be reduced.

According to the present invention, styrene-maleic anhydride copolymer resin and polymethylmethacrylate resin are independently polymerized and then simply blended to prepare a substrate resin. Compared with the conventional copolymer resin prepared by polymerization of polymethylmethacrylate and styrene, this substrate resin exhibits improved heat resistance and physical properties as a light diffusion resin and accordingly bending is inhibited, so that it can be effectively applied to a light diffusion plate with high light diffusivity and brightness.

Particularly, the conventional MS resin has been prepared by polymerization of polymethylmethacrylate with styrene. Thus, water absorption rate can be reduced, but heat resistance cannot be improved since the heat resistance levels of both polymethylmethacrylate and styrene are similar. If a light diffusion plate is exposed on a back-light for a long time, the size of the material can change because of the heat generated by the back-light. Particularly, the MS resin exhibits significant dimensional stability problems because of its low heat resistance. However, the styrene-maleic anhydride copolymer and polymethylmethacrylate resin blend exhibits excellent heat resistance and mechanical properties, so that the resin blend of the present invention can be effectively used as the light diffusion plate of a back-light-unit.

The heat resistant light diffusion blend composition of the present invention can additionally include inorganic or organic transparent micro-particles of b) having a different reflection index to the resin mixture in the substrate resin.

The acrylic organic particles with a mean diameter of 1˜20 μm of b) i) can be \textcircled{1} high molecular resin particles obtained from the polymerization of acrylic monomer alone, \textcircled{2} high molecular resin particles obtained from the polymerization of at least 50 weight % of an acrylic monomer and another monomer having a double bond for radical polymerization, \textcircled{3} cross-linking resin particles obtained by polymerization of an acrylic monomer and another monomer having at least two double bonds for radical polymerization or \textcircled{4} cross-linking resin particles obtained from polymerization of at least 50 weight % of an acrylic monomer, another monomer having one double bond for radical polymerization and another monomer having at least two double bonds for radical polymerization.

The acryl monomer can be one or more compounds selected from a group consisting of ester methacrylic acids such as methyl methacrylic acid, ethyl methacrylic acid, butyl methacrylic acid, cyclohexyl methacrylic acid, phenyl methacrylic acid, benzyl methacrylic acid, 2-ethylhexyl methacrylic acid and 2-hydroxyethyl methacrylic acid; and ester acrylic acids such as methyl acrylic acid, ethyl acrylic acid, butyl acrylic acid, cyclohexyl acrylic acid, phenyl acrylic acid, benzyl acrylic acid, 2-ethylhexyl acrylic acid and 2-hydroxyethyl acrylic acid.

The said monomer having one double bond for radical polymerization is not specifically limited, but an α-substituted styrene such as α-methyl styrene, α-ethyl styrene and α-chloro styrene, or a substituted styrene such as fluoro styrene, chloro styrene, bromo styrene and chloromethyl styrene and their derivatives are preferred.

Other monomers having two double bonds for radical polymerization such as allyl acrylate and allyl methacrylate can be also used.

The acrylic organic particles are preferably 1˜20 μm in size. If the size of the particle is less than 1 μm, light diffusion will be decreased. On the contrary, if the size of the particle is more than 20 μm, a huge amount of acrylic organic particles have to be added to increase the light diffusion effect.

The preferable content of the acrylic organic particles is 0.05˜10 weight part for 100 weight part of the substrate resin of a), and 0.1˜5 weight part is more preferred. If the content is less than 0.05 weight part, light diffusion will not be satisfactory. If the content is more than 10 weight part, impact strength of the final heat resistant light diffusion resin will be reduced, suggesting that when it is applied to a light diffusion plate, the brightness of the product will be reduced.

The silicon organic particles with a mean diameter of 0.5˜20 μm of b) ii) have a structure with a bi-functional siloxane or tri-functional siloxane unit and an organic functional group on its surface.

Particularly, the silicon organic particles are prepared by hydrolysis and condensation of a chlorosilane such as dimethylchlorosilane, diphenylchlorosilane, phenylmethyldichlorosilane, methyltrichlorosilane or phenyltrichlorosilane. The resultant polymer can be reacted with a peroxide such as benzoyl peroxide, 2,4-dichlorobenzoyl peroxide, p-chlorobenzoyl peroxide, dicumyl peroxide, di-tert-butyl peroxide, or 2,5-dimethyl-2,5(tert-butylperoxy)hexane to form a cross-linked polymer. If the resultant polymer contains a silanol terminal group, it can be condensated and cross-linked with any alkoxysilane.

The silicon organic particles are preferably a cross-linked polymer having 2˜3 organic groups per one silicon atom.

The more the silicon organic particles contain silicon atom linked organic groups or phenyl groups, the higher the refraction index of the particles goes. The refraction index of the silicon organic particles of the invention is determined by the composition of the particles, and is preferably 1.39˜1.47.

The silicon organic particles of the present invention are preferably 0.5˜20 to in mean diameter, and 1˜10 μm is more preferred. If the mean diameter of the particles is less than 0.5 μm, which means the particles are smaller than the wavelength of visible light, light diffusion will be poor. On the contrary, if the mean diameter of the particles is more than 20 μm, light diffusivity will be reduced.

The preferable content of the silicon organic particles is 0.05˜10 weight part for 100 weight part of the substrate resin of a), and a content of 0.1˜5 weight part is more preferred. If the content is less than 0.05 weight part, the light diffusion effect will not be satisfactory. On the contrary, if the content is more than 10 weight part, the impact strength of the final heat resistant light diffusion resin will be reduced, suggesting that when it is applied to a light diffusion plate, the brightness of the product will be decreased.

The acrylic organic particles or the silicon organic particles can be used alone or together.

The composition of the present invention can additionally include such inorganic particles as calcium carbonate, barium sulfate, titanium oxide, aluminum hydroxide, silica, glass beads, talc, mica, white carbon, magnesium oxide or zinc oxide, in addition to the acrylic organic particles or silicon organic particles.

The heat resistant light diffusion blend composition of the present invention having the composition above can additionally include a UV stabilizer, a fluorescent bleaching agent, an impact modifier, an anti-electrostatic agent, an antioxidant, a flame retardant, a lubricant or a dye.

The present invention further provides a light diffusion plate containing the heat resistant light diffusion blend composition of the present invention.

The heat resistant light diffusion blend composition can be applied to display backlights, lighting apparatus, signboards, glass showcases, etc, by means of extrusion molding, compression molding or injection molding. Particularly, the composition of the present invention can be applied to a light diffusion plate for displays including lighting signboards equipped with a cold cathode fluorescent lamp and LED like light source, lighting covers, or direct backlights or edge lit configuration backlights for LCDs, etc.

The heat resistant light diffusion blend composition of the present invention has excellent diffusivity and brightness, which favors use as a light diffusion plate, and excellent heat resistance, dimensional stability and mechanical properties with a low water absorption rate, so that it can be effectively applied as a backlight for LCDs, lighting apparatus, signboards or glass showcases.

### BRIEF DESCRIPTION OF THE DRAWINGS

The application of the preferred embodiments of the present invention is best understood with reference to the accompanying drawings, wherein:

FIG. 1 is a graph illustrating the storage modulus of different light diffusion plates respectively loaded with the heat resistant light diffusion resin prepared in the examples of the present invention, prepared in Comparative Example 1 with the substrate resin content out of the acceptable content range, and prepared in Comparative Example 2 with polymethylmethacrylate resin alone.

### BEST MODE FOR CARRYING OUT THE INVENTION

Practical and presently preferred embodiments of the present invention are illustrated as shown in the following examples.

However, it will be appreciated that those skilled in the art, on consideration of this disclosure, may make modifications and improvements within the spirit and scope of the present invention.

### EXAMPLES

### Example 1

90 weight % of styrene-maleic anhydride copolymer (SMA, Dylark332, MAH=15 weight %, NOVA Chemical.), a transparent resin, and 10 weight % of polymethylmethacrylate (PMMA, IG840, LG Chem.) were blended, resulting in 100 weight part of a substrate resin. To 100 weight part of the substrate resin were added 1.0 weight part of acrylic organic particles (MA1002, Nippon Sholkubai) and 0.2 weight part of silicon organic particles (DY33-719, Dow-corning) as a light diffusing agent, followed by mixing with a Henschel mixer. Then, a pellet type resin was prepared by using an extruder (Leistritz, 27φ, L/D=48). The prepared pellet was dried and processed into a light diffusion plate using a sheet extruder.

### Example 2

An experiment was performed in the same manner as described in Example 1 except that, as shown in Table 1, to 100 weight part of a substrate resin prepared by blending 80 weight % of styrene-maleic anhydride copolymer (Dylark232, MAH=8 weight %, NOVA Chemical.) and 20 weight % of polymethylmethacrylate was added 1.4 weight part of acrylic particles as a light diffusing agent.

### Example 3

An experiment was performed in the same manner as described in Example 1 except that, as shown in Table 1, to 100 weight part of a substrate resin prepared by blending 80 weight % of styrene-maleic anhydride copolymer (Dylark332, MAH=15 weight %, NOVA Chemical.) and 20 weight part of polymethylmethacrylate were added 1.4 weight part of acrylic organic particles and 0.1 weight part of silicon organic particles as a light diffusing agent.

### Example 4

An experiment was performed in the same manner as described in Example 1 except that, as shown in Table 1, to 100 weight part of a substrate resin prepared by blending 70 weight % of styrene-maleic anhydride copolymer (Dylarl(332, MAU=15 weight %, NOVA Chemical.) and 30 weight % of polymethylmethacrylate was added 0.4 weight part of silicon organic particles (DY33-719, Dow-coming) as a light diffusing agent.

### Example 5

An experiment was performed in the same manner as described in Example 1 except that, as shown in Table 1, to 100 weight part of a substrate resin prepared by blending 60 weight % of styrene-maleic anhydride copolymer (Dylark332, MAH=15 weight %, NOVA Chemical.) and 40 weight % of polymethylmethacrylate was added 0.4 weight part of silicon organic particles (DY33-719, Dow-corning) as a light diffusing agent.

### Example 6

An experiment was performed in the same manner as described in Example 1 except that, as shown in Table 1, to 100 weight part of a substrate resin prepared by blending 50 weight % of styrene-maleic anhydride copolymer (Dylark332, MAH=15 weight %, NOVA Chemical.) and 50 weight part of polymethylmethacrylate were added 1.0 weight part of acrylic organic particles and 0.3 weight part of silicon organic particles as a light diffusing agent.

### Example 7

An experiment was performed in the same manner as described in Example 1 except that, as shown in Table 1, to 100 weight part of a substrate resin prepared by blending 25 weight % of styrene-maleic anhydride copolymer (Dylark332, MAH=15 weight %, NOVA Chemical.) and 75 weight part of polymethylmethacrylate were added 0.8 weight part of acrylic organic particles and 0.3 weight part of silicon organic particles as a light diffusing agent.

### Comparative Example 1

An experiment was performed in the same manner as described in Example 1 except that, as shown in Table 1, to 100 weight part of a substrate resin prepared by blending 10 weight % of styrene-maleic anhydride copolymer (Dylark332, MAH=15 weight %, NOVA Chemical.) and 90 weight % of polymethylmethacrylate were added 1.0 weight part of acrylic organic particles and 1.0 weight part of silicon organic particles as a light diffusing agent.

### Comparative Example 2

An experiment was performed in the same manner as described in Example 1 except that, as shown in Table 1, to 100 weight part of a substrate resin composed of 100 weight % of polymethylmethacrylate were added 1.0 weight part of silicon organic particles.

### Comparative Example 3

An experiment was performed in the same manner as described in Example 1 except that, as shown in Table 1, to 100 weight part of a substrate resin composed of 100 weight % of polymethylmethacrylate were added 5.0 weight part of glass beads.

TABLE 1

| | | | Acrylic | Silicon | |
|---|---|---|---|---|---|
| | Substrate Resin | | organic | organic | Glass bead |
| | SMA | PMMA | particle | particle | Particle |
| Example 1 | 90 weight % | 10 weight % | 1.0 weight part | 0.2 weight part | — |
| Example 2 | 80 weight % | 20 weight % | 1.4 weight part | — | — |
| Example 3 | 80 weight % | 20 weight % | 1.4 weight part | 0.1 weight part | — |
| Example 4 | 70 weight % | 30 weight % | — | 0.4 weight part | — |
| Example 5 | 60 weight % | 40 weight % | — | 0.4 weight part | — |
| Example 6 | 50 weight % | 50 weight % | 1.0 weight part | 0.3 weight part | — |
| Example 7 | 25 weight % | 75 weight % | 0.8 weight part | 0.3 weight part | — |
| Comparative | 10 weight % | 90 weight % | 1.0 weight part | 1.0 weight part | — |
| Example 1 | | | | | |
| Comparative | — | 100 weight % | — | 1.0 weight part | — |
| Example 2 | | | | | |
| Comparative | — | 100 weight % | — | — | 5.0 weight part |
| Example 3 | | | | | |

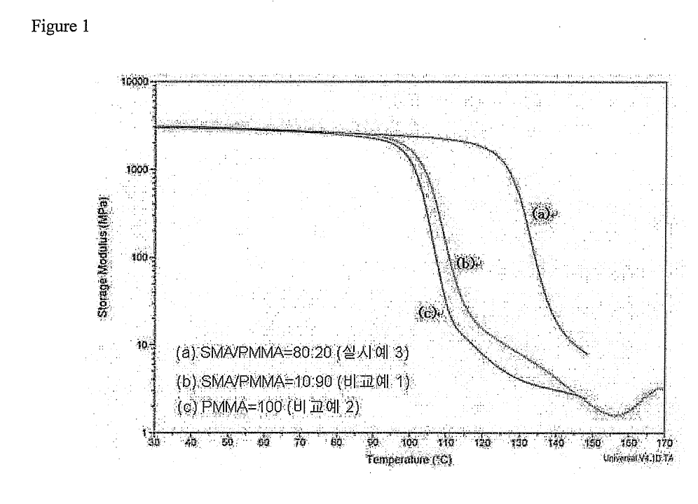

The prepared light diffusion plates of Examples 1˜7 and Comparative Examples 1˜3 were tested for light transmittance, light diffusivity, brightness, water absorption rate, bending property, high temperature modulus, glass transition temperature and storage modulus. The results are shown in FIG. 1, Table 2 and Table 3.

a) Total light transmittance and light diffusivity (haze)—measured by using a haze transmittance meter (HR-100, Murakami Color Research Laboratory) by JIS K 7105.

b) Brightness—The light diffusion plates of Examples 1˜7 and Comparative Examples 1˜3 were applied to the direct backlight of a 32″ LG-Philips LCD and then brightness was measured 50 cm away from each light diffusion plate by using BM-7.

c) Water absorption rate—The light diffusion plates of Examples 1˜7 and Comparative Examples 1˜3 were cut into 5 cm×15 cm fragments, which were dried for 24 hours in an 80° C. oven. The weights (Wo) of the dried samples were measured and the dried samples were immersed for 10 days in distilled water at room temperature. Then the weight of each sample was measured again and water absorption rate was calculated therefrom (Wab=(W−Wo)/Wo×100(%)).

d) Bending property—The light diffusion plates of Examples 1˜7 and Comparative Examples 1˜3 were cut into 30 cm×2 cm fragments, which were heated for 5 hours in between 80° C. steel plates. Then the samples were cooled down for 24 hours, resulting in flat samples. Those samples were put in a 25 cm×30 cm container, to which water was added to suck the lower parts of the samples, and the samples were left as they were for 24 hours. Bending was measured (mm) at both edges of each sample.

e) High temperature modulus and storage modulus—measured by using dynamic mechanical analyzer DMA Q800 under the conditions of frequency of 1 hz, amplitude of 30 μm and temperature raising speed of 2° C./min.

f) Glass transition temperature—measured by using DSC (Differential scanning calorimeter, TA DSC 2010) at a speed of 5° C./min over the temperature range of 25˜250° C.

TABLE 2

| | Total light | | | | |
|---|---|---|---|---|---|
| | trans- | Light | | Water | |
| | mittance | diffusivity | Bright- | absorption | Bending |
| | (Tt) | (Haze) | ness | rate (%) | (mm) |
| Example 1 | 78.6 | 84.5 | 5.290 | 0.18 | 1.07 |
| Example 2 | 76.1 | 84.5 | 5.360 | 0.32 | 1.21 |
| Example 3 | 73.3 | 84.6 | 5.220 | 0.31 | 1.20 |
| Example 4 | 71.2 | 84.5 | 5.80 | 0.45 | 1.95 |
| Example 5 | 69.9 | 84.5 | 5.260 | 0.64 | 2.02 |
| Example 6 | 70.6 | 84.6 | 5.310 | 0.71 | 2.26 |
| Example 7 | 70.4 | 84.5 | 5.140 | 0.88 | 2.32 |
| Comparative | 64.1 | 84.2 | 5.100 | 1.10 | 2.99 |
| Example 1 | | | | | |
| Comparative | 62.0 | 84.3 | 5.070 | 1.15 | 3.08 |
| Example 2 | | | | | |
| Comparative | 77.5 | 78.9 | 4.990 | 0.95 | 2.59 |
| Example 3 | | | | | |

TABLE 3

| | | Glass transition | Storage |
|---|---|---|---|
| | | temperature | modulus (MPa |
| | Substrate resin | (° C.) | at 100° C.) |
| Example 3 | SMA/PMMA = 80:20 | 137 | 2,381 |
| Comparative | SMA/PMMA = 10:90 | 113 | 1,650 |
| Example 1 | | | |
| Comparative | PMMA = 100 | 110 | 1,223 |
| Example 2 | | | |

As shown in FIG. 1, Table 2 and Table 3, the light diffusion plates loaded with the heat resistant light diffusion blend composition of the present invention, prepared in Examples 1˜7, were confirmed to have excellent total light transmittance, light diffusivity, brightness, bending property, high temperature modulus, glass transition temperature and storage modulus, with a low water absorption rate, compared with the plates of Comparative Examples 1˜3.

In particular, as shown in Table 2, the plates containing polymethylmethacrylate as the major component for the substrate resin of Comparative Examples 1 3 were confirmed to have a high water absorption rate and accordingly high bending of the light diffusion plate was observed. In the case of the plate of Comparative Example 3 containing glass beads as a light-diffusing agent, total light transmittance was not improved and haze (light diffusivity) was rapidly reduced, suggesting that it is not appropriate as a light diffusion plate, or if applied it will reduce brightness.

According to the embodiments of the present invention, the lower the polymethylmethacrylate content, the lower the water absorption rate goes and thereby the less the chances of the light diffusion plate bending.

As shown in FIG. 1 and Table 3, the light diffusion plate of Example 3 exhibited a glass transition temperature of 137° C. and storage modulus of 2,381 MPa. In the meantime, both the light diffusion plate containing the substrate resin content out of the acceptable range prepared in Comparative Example 1 and the light diffusion plate loaded with only polymethylmethacrylate resin prepared in Comparative Example 2 were confirmed to have a reduced glass transition temperature and storage modulus.

### INDUSTRIAL APPLICABILITY

As explained hereinbefore, the heat resistant light diffusion blend composition of the present invention has high diffusivity and brightness, which is suitable for use as a light diffusion plate, and excellent heat resistance, dimensional stability and mechanical properties with a low water absorption rate, so that it can be effectively applied as a backlight for LCDs, lighting apparatus, signboards or glass showcases, etc.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

1. A heat resistant light diffusion blend composition, which comprises:
a) 100 weight part of a substrate resin prepared by blending
i) 20˜90 weight % of styrene-maleic anhydride copolymer resin, and
ii) 10˜80 weight % of polymethylmethacrylate resin; and
b) a light-diffusing agent prepared by blending either
i) 0.05˜10 weight part of acrylic organic particles with a mean diameter of 1-20 μnm, or
ii) 0.05˜10 weight part of silicon organic particles with a mean diameter of 0.5˜20 μm, or a mixture thereof.

2. The heat resistant light diffusion blend composition according to claim 1, wherein the styrene-maleic anhydride copolymer resin of a) i) is prepared by the copolymerization of 70˜96 weight % of styrene monomer and 4˜30 weight % of maleic anhydride monomer.

3. The heat resistant light diffusion blend composition according to claim 1, wherein the polymethylmethacrylate resin of a) ii) is a polymer harboring at least 50 weight % of methyl methacrylic acid methylester.

4. The heat resistant light diffusion blend composition according to claim 1, wherein the polymethylmethacrylate resin of a)ii) is a polymer polymerized with methyl methacrylic acid methylester alone or copolymerized with at least 50 weight % of methyl methacrylic acid methylester and up to 50 weight % of an unsaturated monomer copolymerizable with the above.

5. The heat resistant light diffusion blend composition according to claim 4, wherein the unsaturated monomer copolymerizable with methyl methacrylic acid methylester is one or more compounds selected from a group consisting of ethyl methacrylic acid, butyl methacrylic acid, cyclohexyl methacrylic acid, phenyl methacrylic acid, benzyl methacrylic acid, 2-ethylhexyl methacrylic acid, 2-hydroxyethyl methacrylic acid, methyl acrylic acid, ethyl acrylic acid, butyl acrylic acid, cyclohexyl acrylic acid, phenyl acrylic acid, benzyl acrylic acid, 2-ethylhexyl acrylic acid, 2-hydroxyethyl acrylic acid, styrene, α-methyl styrene, acrylonitrile, phenyl maleimide and cyclohexyl maleimide.

6. The heat resistant light diffusion blend composition according to claim 1, wherein the acrylic organic particles with a mean diameter of 1˜20 μm of b) i) are selected from a group consisting of (I) high molecular resin particles obtained from the polymerization of an acrylic monomer alone, (Z high molecular resin particles obtained from the polymerization of at least 50 weight % of an acrylic monomer and another monomer having a double bond for radical polymerization, (3) cross-linking resin particles obtained by polymerization of an acrylic monomer and another monomer having at least two double bonds for radical polymerization and (4 cross-linking resin particles obtained from polymerization of at least 50 weight % of an acrylic monomer, another monomer having one double bond for radical polymerization and another monomer having at least two double bonds for radical polymerization.

7. The heat resistant light diffusion blend composition according to claim 1, wherein the silicon organic particles with a mean diameter of 0.5˜20 μm of b) ii) have a structure formed by a bi-functional siloxane or tri-functional siloxane unit and an organic functional group on its surface.

8. The heat resistant light diffusion blend composition according to claim 1, wherein the light-diffusing agent of b) additionally includes one or more inorganic particles selected from a group consisting of calcium carbonate, barium sulfate, titanium oxide, aluminum hydroxide, silica, glass beads, talc, mica, white carbon, magnesium oxide and zinc oxide.

9. The heat resistant light diffusion blend composition according to claim 1, wherein the composition additionally includes one or more additives selected from a group consisting of a UV stabilizer, a fluorescent bleaching agent, an impact modifier, an anti-electrostatic agent, an antioxidant, a flame retardant, a lubricant and a dye.

10. A light diffusion plate in which the heat resistant light diffusion blend composition of claim 1 is loaded.

11. The light diffusion plate according to claim 10, which is applied as a backlight for LCDs, lighting apparatus, signboards or glass showcases.
